(19) United States
(12) Patent Application Publication
(10) Pub. No.: US 2008/0314089 A1
(43) Pub. Date: Dec. 25, 2008

(54) ALUMINUM ALLOY CONNECTING AND SUPPORTING DEVICE FOR GLASS CONSTRUCTION PROJECT

(76) Inventor: Jen-Chieh Ting, Kaohsiung City (TW)

Correspondence Address: SINORICA, LLC, 528 FALLSGROVE DRIVE, ROCKVILLE, MD, 20850, US

(21) Appl. No.: 11/767,437

(22) Filed: Jun. 22, 2007

(51) Int. Cl. C03B 9/48

(52) U.S. Cl. 65/374.12

(57) ABSTRACT

Aluminum alloy connecting and supporting device for a glass construction project mainly includes a base, extension rods, glass clamping-connecting rods and glass clamping-connecting members, which are made of aluminum alloy and connected with one another by means of pivots. The aluminum alloy connecting and supporting device of this invention can be used for connecting glass of different specifications, of different locating points or of different shapes, able to shorten time needed for glass assembling work and able to assemble and connect glass conveniently, stably and safely.

### BACKGROUND OF THE INVENTION

1. Field of Invention

This invention relates to an aluminum alloy connecting and supporting device for a glass construction project, particularly to one able to increase convenience and applicability in use, save cost of producing different-sized extension rods, speed up glass assembling work and enhance safety after glass is assembled.

2. Description of the Related Art

Generally, a conventional glass supporting and connecting device can only be employed for construction of glass with certain specifications, that is, the space between every two panes of glass must be of the same because the extension rods of the conventional glass supporting-and-connecting device are made of cast iron formed integral by casting and cannot be changed in length. Therefore, when panes of glass with special specifications are to be assembled, special extension rods have to be made for assembling such glass, thus increasing cost and time in assembly. In addition, when assembled by means of the conventional glass supporting and connecting device, panes of glass must be on a same level without height difference and cannot be curved, resulting in much inconvenience in assembly.

### SUMMARY OF THE INVENTION

The objective of this invention is to offer aluminum alloy connecting and supporting device for a glass construction project, able to assemble and connect glasses of different specifications, of different locations or at different angles.

The aluminum alloy connecting-and-supporting device for a glass construction project in the present invention includes a base, extension rods, connecting rods, glass clamping-connecting rods and glass clamping-connecting members.

The base made of aluminum alloy has a plurality of combining holes with their upper ends respectively formed with a receiving recess communicating with the combining hole and having a comparatively large diameter. A gasket whose thickness is larger than the depth of the receiving recess is received in the receiving recess for reinforcing combined stability of the base.

The extension rod made of aluminum alloy has one end bored with a combining hole corresponding with the combining hole of the base. The extension rod and the base are combined together by a pivot locked in the combining holes of the extension rod and the base. The extension rod is able to be turned and shifted to different locations.

The connecting rod made of aluminum alloy has one end connected with the outer end of the extension rod by means of a pivot. One or more connecting rods can be connected with the extension rod to lengthen the whole rod body for facilitating assembling glasses at different locations and angles or at different distances, especially applicable to assembling, adjusting and changing angles of small-sized or arc-shaped glass.

The glass clamping-connecting rod made of aluminum alloy and somewhat curved has one end formed with a U-shaped engage member to be engaged with the inverted m-shaped engage member of the extension rod or with the corresponding engage member of the connecting rod. The glass clamping-connecting rod is bored with an adjusting hole at a proper location for fitting the glass clamping-connecting member and adjusting it to a proper position for carrying out glass assembling work. In other words, the adjusting hole of the glass clamping-connecting rod can function to adjust glass locating errors, able to lessen time needed for glass assembling work and save cost in producing different-shaped supporting frames.

The glass clamping-connecting member is composed of a glass outer cover, a glass cushion, a glass inner cover, a threaded rod, a front nut and a rear nut. The glass clamping-connecting member is fitted in the adjusting hole of the glass clamping-connecting rod for stably fixing glass in position to prevent the glass from falling down and injuring people.

### BRIEF DESCRIPTION OF THE DRAWINGS

This invention will be better understood by referring to the accompanying drawings, wherein:

FIG. 1 is a perspective view of an aluminum alloy connecting and supporting device for a glass construction project in the present invention;

FIG. 2 is an exploded perspective view of the aluminum alloy connecting and supporting device for a glass construction project in the present invention;

FIG. 3 is a perspective and cross-sectional view of a base in the present invention;

FIG. 4 is an upper view of an extension rod and a glass clamping-connecting rod connected together in the present invention;

FIG. 5 is a side cross-sectional view of a glass clamping-connecting member in the present invention;

FIG. 6 is an exploded perspective view of a first preferred embodiment of the glass clamping-connecting member in the present invention;

FIG. 7 is an exploded perspective view of a second preferred embodiment of the glass clamping-connecting member in the present invention.

### DETAILED DESCRIPTION OF THE INVENTION

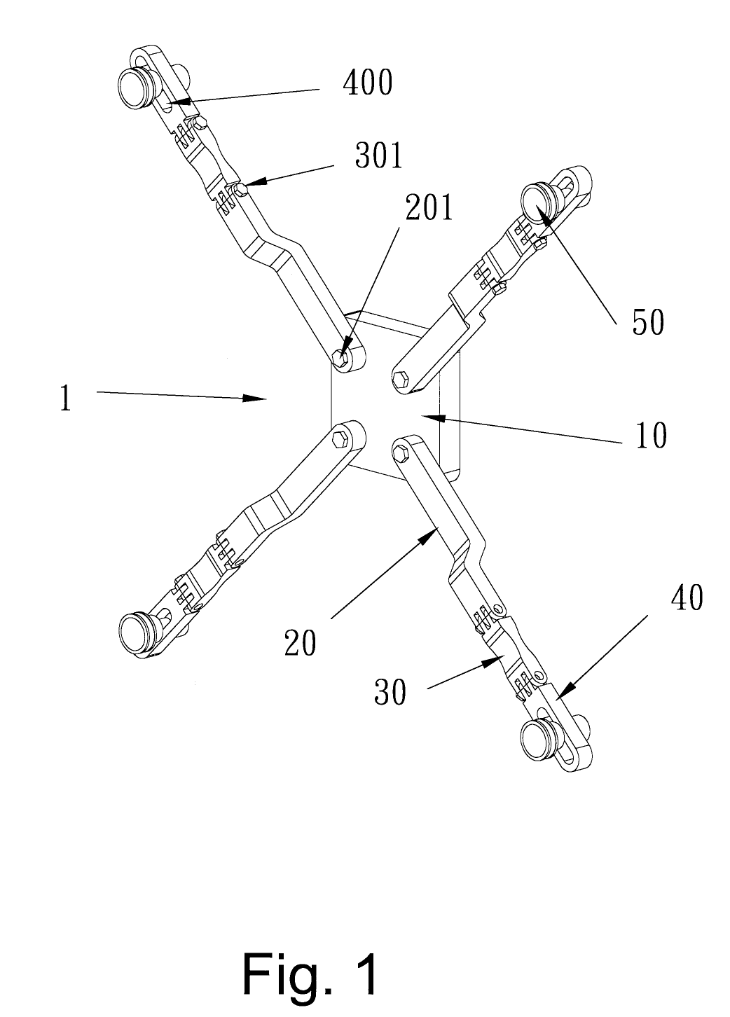

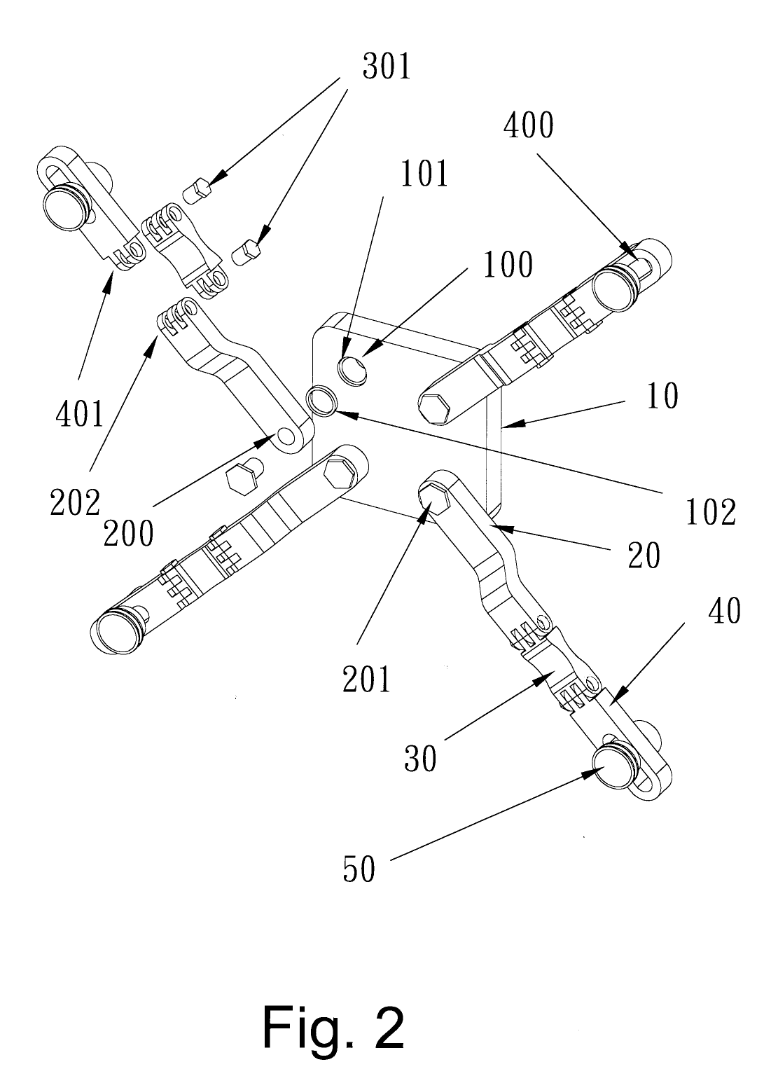

A preferred embodiment of an aluminum alloy connecting and supporting device 1 for glass construction project in the present invention, as shown in FIGS. 1 and 2, includes a base 10, extension rods 20, connecting rods 30, glass clamping-connecting rods 40 and glass clamping-connecting members 50 combined together.

The base 10 made of aluminum alloy has a plurality of combining holes 100 with their upper ends respectively formed with a receiving recess 101 communicating with the combining hole 100 and having a comparatively larger diameter than the combining hole 100. The receiving recesses 101 respectively receive a gasket 102 having a larger thickness than the depth of the receiving recess 101. After being tightly locked in the receiving recess 101, the gasket 102 is able to reinforce the holding force of the base 10 after combined and greatly elevate the strength of bearing heavy loads.

The extension rods 20 are made of aluminum alloy, respectively having one end bored with a combining hole 200 corresponding with the combining hole 100 of the base 10. The extension rod 20 and the base 10 are connected together by means of a pivot 201 locked in the combining holes 200 and 100, and the gasket 102 is firmly positioned between the base 10 and the extension rod 20.

The connecting rod 30 made of aluminum alloy has one end connected with the outer end of the extension rod 20 and the inner end connected with the glass clamping-connecting rod 40 by means of a pivot 301. Thus, one or more connecting rods 30 can be connected between the extension rod 20 and the glass clamping-connecting rod 40 to properly lengthen the rod body for facilitating glass assembling work at different locations, angles or distances.

The glass clamping-connecting rod 40 made of aluminum alloy has one end connected with the outer end of the extension rod 20 or one end of the connecting rod 30 and the other end bored with an adjusting hole 400 for fitting and adjusting the glass clamping-connecting member 50 to a suitable location for carrying out glass assembling work.

The glass clamping-connecting member 50 made of aluminum alloy is fitted in the adjusting hole 400 of the glass clamping-connecting rod 40 and is able to firmly fixing glass in position to prevent the glass from falling down and injuring people.

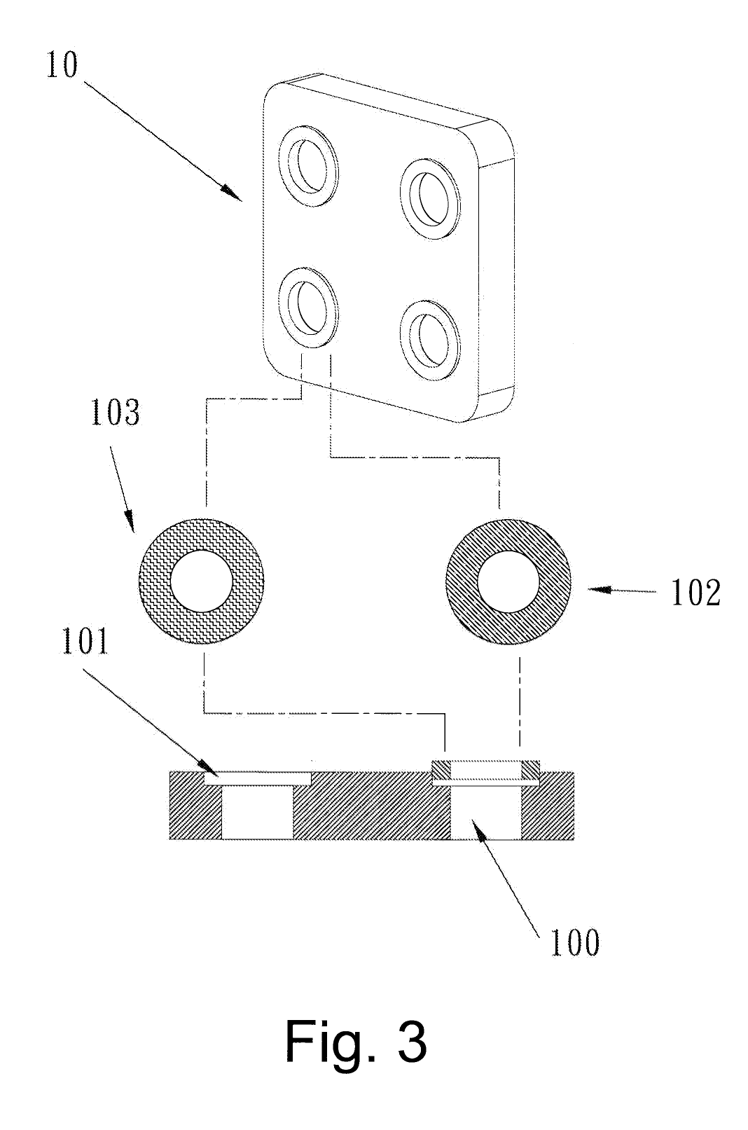

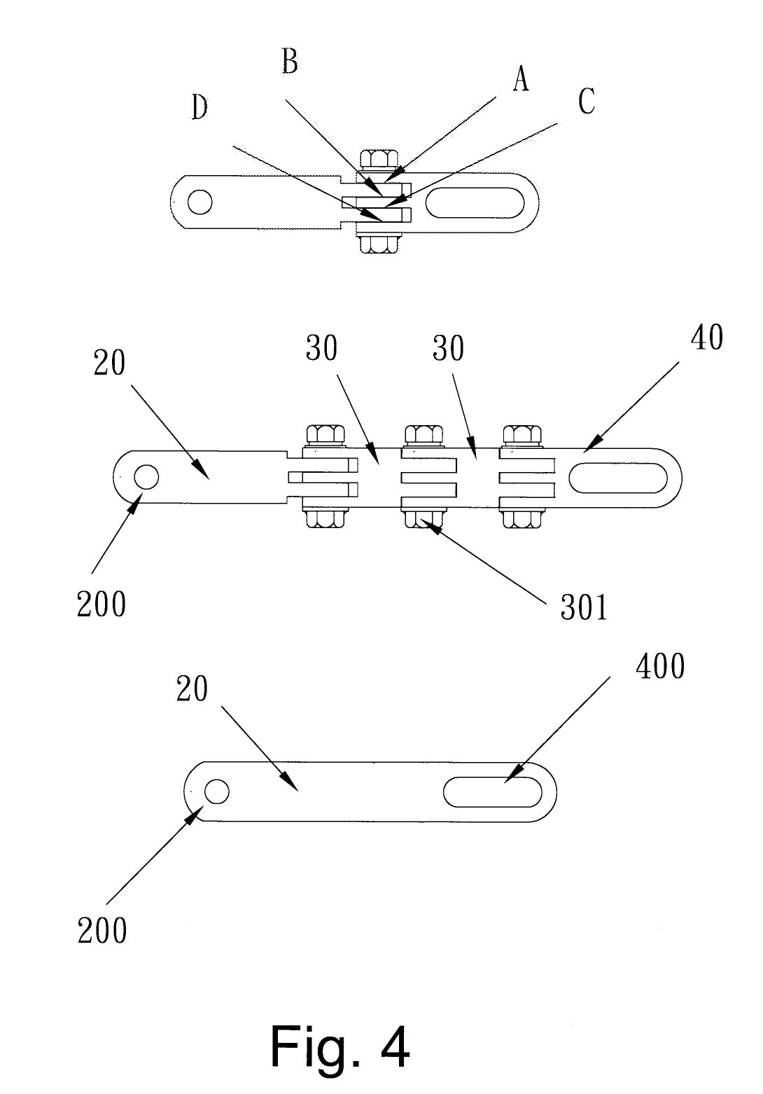

Specifically, referring to FIGS. 2, 3 and 4, the base 10 has a plurality of the combining holes 100 with their upper ends respectively provided with the receiving recess 101 communicating with the combining hole 100 and having comparatively large diameter for receiving the gasket 102 or a non-slip gasket 103 with toothed streaks on both sides. The gasket 102 or 103 has a thickness larger than the depth of the receiving recess 101. After being locked tight, the gasket 102 or 103 is able to reinforce the combined stability of the base 10 and the extension rod 20 and enhance the holding force of the device and also increase the strength of bearing heavy loads.

The extension rod 20 has its outer end formed with an inverted m-shaped engage member 202, and the glass clamping-connecting rod 40 has one end formed with a U-shaped engage member 401 to be engaged with the inverted m-shaped engage member 202 of the extension rod 20. After the engage members 202 and 401 of the extension rod 20 and the glass clamping-connecting rod 40 are engaged together, they are formed with four contact surfaces A, B, C, D closely contacting with one another and inserted therethrough by a pivot 301 to connect the extension rod 20 and the glass clamping-connecting rod 40 together. In addition, one or more connecting rods 30 can be connected between the extension rod 20 and the glass clamping-connecting rod 40 to extend the connected rod for a proper distance for facilitating assembling, adjusting and changing angles of small-sized or arc-shaped glass. Moreover, the extension rod 20 and the glass clamping-connecting rod 40 can be integrally made into a single member with a curved or a straight-line shape.

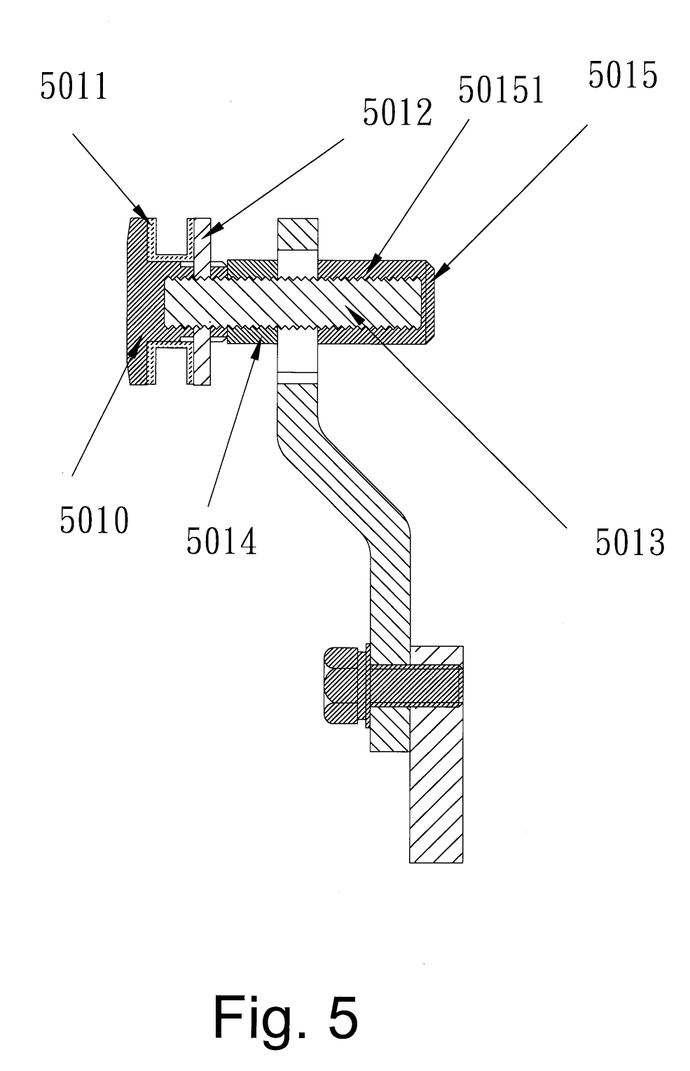

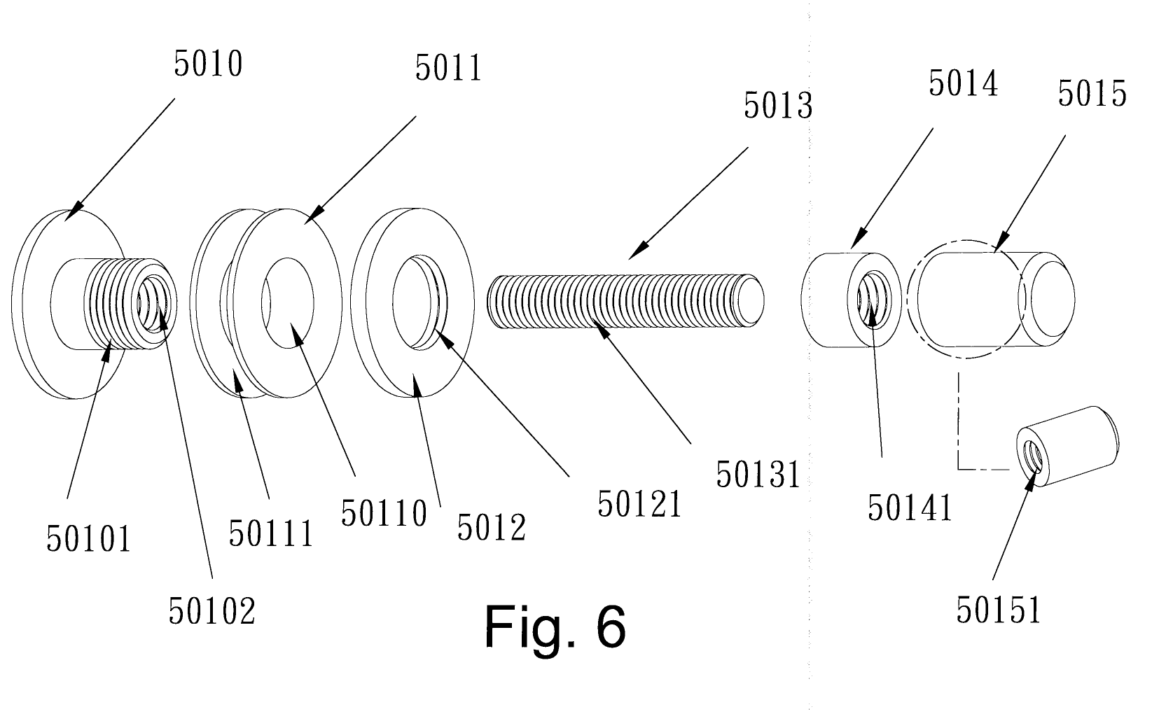

A first preferred embodiment of the glass clamping-connecting member 50, as shown in FIGS. 5 and 6, includes a glass outer cover 5010, a glass cushion member 5011, a glass inner cover 5012, a threaded rod 5013, a front nut 5014 and a rear nut 5015 combined together.

The glass outer cover 5010 is a hollow T-shaped body made of aluminum alloy, provided with male threads 50101 on the surface of a lower portion for connecting other members and its hollow center provided therein with female threads 50102 to be connected with the threaded rod 5013.

The glass cushion 5011 is a sidewise H-shaped body made of rubber, having its center bored with a through hole 50110 to be fitted on the glass outer cover 5010 and having its outer end closely contact with the inner end of the glass outer cover 5010. The glass cushion 5011 is disposed with a recessed groove 50111 in the outer circumferential side between its opposite ends for stably fixing glass therein so as to prevent the glass from falling down and from being locked tight with excessively large force to break potentially the glass.

The glass inner cover 5012 is a circular body made of aluminum alloy, having its center bored with a through round hole provided therein with female threads 50121 to be combined with the male threads 50101 on the surface of the glass outer cover 5010, letting the outer end of the glass inner cover 5012 closely contact with the inner end of the glass cushion 5011. Therefore, after the inner cover 5012 is turned tight, the glass cushion 5011 will be forced to closely contact with the glass outer cover 5010.

The threaded rod 5013 made of stainless steel has its surface provided with male threads 50131 by which the outer end of the threaded rod 5013 can be combined with the female threads 50102 of the glass outer cover 5010.

The front nut 5014 is a hollow cylinder made of aluminum alloy, having its center bored with a through round hole provided therein with female threads 50141 to be combined with the male threads 50131 of the threaded rod 5013, letting the outer end of the front nut 5014 closely contact with the outer end of the round hole of the glass outer cover 5010.

The rear nut 5015 is a sidewise U-shaped body made of aluminum alloy, having the inner portion of its hole disposed with female threads 50151 by which the rear nut 5015 can be connected with the rear end of the threaded rod 5013. Thus, by turning the rear nut 5015, the threaded rod 5013 can be adjusted to a proper length tallying with the total thickness of the members fitted on the threaded rod 5013 so as to enable all the members to closely contact with one another and be firmly secured together after the rear nut 5015 is turned tight.

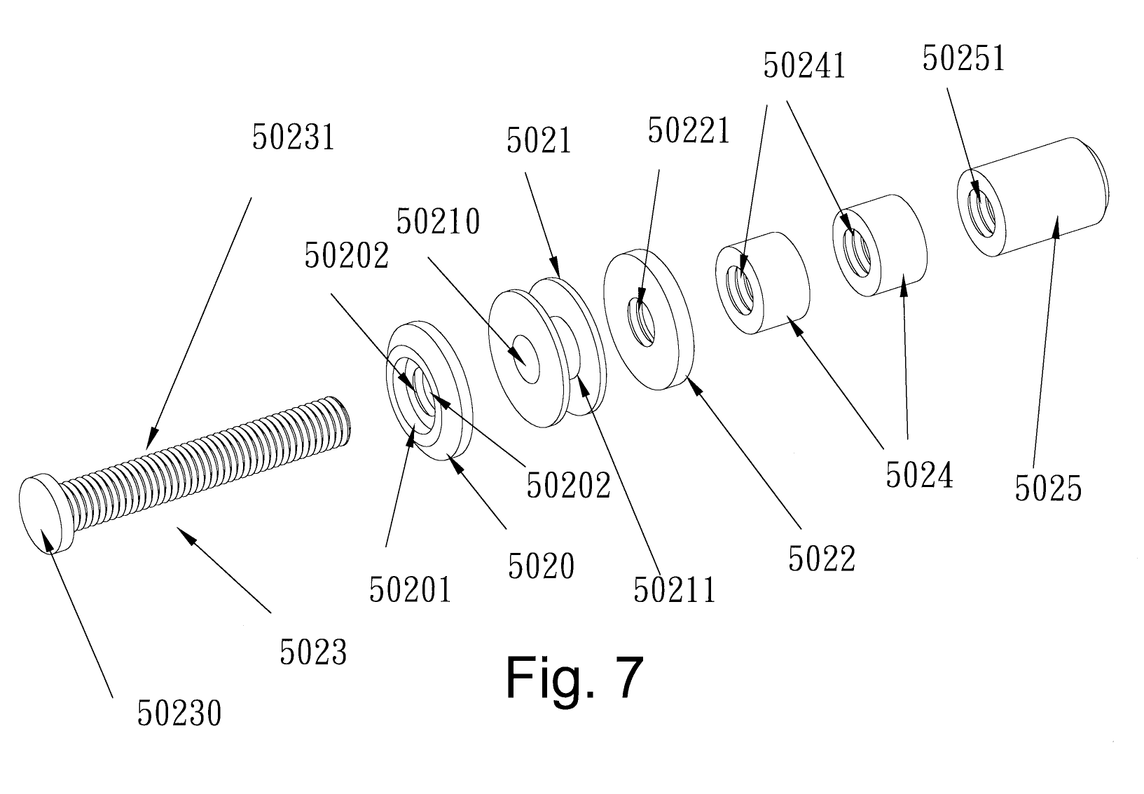

A second preferred embodiment of the glass clamping-connecting member 50 in the present invention, as shown in FIG. 7, has almost the same structure as that described in the first preferred embodiment, except that the glass outer cover 5020 has its center bored with a through insert hole 50200 having its upper end cut with a receiving recess 50201 communicating with the through insert hole 50200, and that the threaded rod 5023 has one end expanded outward and formed with a flat bolt head 50230 to be received in the receiving recess 50201 of the glass outer cover 5020. The other members in the second preferred embodiment respectively have the same structure as that described in the first preferred embodiment, including the glass cushion 5021, the glass inner cover 5022, the front nut 5024, the rear nut 5025, the male threads 50231 of the threaded rod 5023, the female threads 50202, 50221, 50241 and 50251, the recessed groove 50211 of the glass cushion 5021, and the through insert hole 50210 of the glass cushion member 5021.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. An aluminum alloy connecting and supporting device for a glass construction project said device comprising:
a base made of aluminum alloy and having its surface bored with a plurality of combining holes;
extension rods being made of aluminum alloy, each said extension rod having one end bored with a combining hole, said extension rods combined with said base by means of pivots respectively locked in said combining holes of said extension rod and said base;
glass clamping-connecting rods made of aluminum alloy and respectively having one end connected with the outer end of said extension rod and the other end bored with an adjusting hole; and
glass clamping-connecting members made of aluminum alloy and fitted in said adjusting hole of said glass clamping-connecting rod, said glass clamping-connecting members clamping and fixing glass in position.

2. The aluminum alloy connecting and supporting device for a glass construction project as claimed in claim 1, wherein each said extension rod has one end formed with an inverted m-shaped engage member, and each said glass clamping-connecting rod has one end formed with a U-shaped engage member to be engaged with said inverted m-shaped engage member of said extension rod, said engage members of each said extension rod and each said glass clamping-connecting rod engaged mutually and formed with four contact surfaces closely contacting with one another, each said extension rod firmly connected with each said glass clamping-connecting rod by means of a pivot inserted through said engage members to lock them together.

3. The aluminum alloy connecting and supporting device for a glass construction project as claimed in claim 1, wherein each said combining hole of said base has its upper end provided with a receiving recess communicating with said combining hole and having a comparatively large diameter, a stainless steel gasket received in said receiving recess and locked between said base and said extension rod, said gasket having a thickness larger than the depth of said receiving recess and protruding out of said receiving recess.

4. The aluminum alloy connecting and supporting device for a glass construction project as claimed in claim 3, wherein said gasket is a non-slip gasket formed with toothed streaks on both sides.

5. The aluminum alloy connecting and supporting device for glass construction project as claimed in claim 1, wherein said extension rod and said glass clamping-connecting rod are integrally formed into a straight-line member.

6. The aluminum alloy connecting and supporting device for glass construction project as claimed in claim 1, wherein one or more connecting rods are connected between said extension rod and said glass clamping-connecting rod for lengthening the whole rod body according to practical needs.

7. The aluminum alloy connecting and supporting device for a glass construction project as claimed in claim 1, wherein said extension rod and said glass clamping-connecting rod are arc-shaped members.

8. The aluminum alloy connecting and supporting device for a glass construction project as claimed in claim 1, wherein said glass clamping-connecting member comprises:
a glass outer cover being a hollow T-shaped body made of aluminum alloy, said glass outer cover having its surface provided with male threads in a lower portion, said glass outer cover formed with an inner hole provided therein with female threads;
a glass cushion being a hollow sidewise H-shaped body made of rubber, said glass cushion member disposed with an annular recessed groove in the circumferential side between its two opposite ends for positioning glass therein, said glass cushion fitted on said glass outer cover;
a glass inner cover being a hollow circular body made of aluminum alloy, said glass inner cover threadably combined with said male threads on the surface of said glass outer cover, said glass inner cover having its outer end contacting with the inner end of said glass cushion;
a threaded rod made of stainless steel, and having its surface disposed thereon with male threads, said threaded rod having an outer end combined with said inner hole of said glass outer cover;
a front nut shaped as a hollow cylinder made of aluminum alloy, said front nut combined with said male threads of said threaded rod, said front nut having its outer end contacting with the inner end of said glass inner cover; and
a rear nut made of aluminum alloy, said rear nut threadably combined with the rear end of said threaded rod.

9. The aluminum alloy connecting and supporting device for a glass construction project as claimed in claim 1, wherein each said glass clamping-connecting member comprises:
a threaded rod made of stainless steel, and having one end expanded outward to form a flat bolt head, said threaded rod having its surface provided with male threads;
a glass outer cover made of aluminum alloy, and having its center bored with a through insert hole, said through insert hole having its upper end formed with a receiving recess communicating with said through insert hole, said flat bolt head of said threaded rod received in said receiving recess of said glass outer cover;
a glass cushion being a hollow sidewise H-shaped body made of rubber, said glass cushion provided with an annular recessed groove in the outer circumferential side between its opposite ends for positioning glass therein, said glass cushion fitted on said threaded rod;
a glass inner cover shaped as a hollow circular body made of aluminum alloy, said glass inner cover combined with said male threads of said threaded rod, said glass inner cover having one end contacting with said glass cushion member;
a front nut shaped as a hollow cylinder made of aluminum alloy, said front nut combined with said male threads on the surface of said threaded rod, said front nut having one end contacting with said glass inner cover; and
a rear nut made of aluminum alloy and formed with a hole provided with female threads, said rear nut threadably combined with the rear end of said threaded rod.
